(19) United States
(12) Patent Application Publication
(10) Pub. No.: US 2023/0278526 A1
(43) Pub. Date: Sep. 7, 2023

(54) Theft Deterrent System for a Catalytic Converter

(71) Applicant: Sean Heath Broadnax, Elk Grove, CA (US)

(72) Inventor: Sean Heath Broadnax, Elk Grove, CA (US)

(21) Appl. No.: 18/179,200

(22) Filed: Mar. 6, 2023

Related U.S. Application Data
(60) Provisional application No. 63/316,877, filed on Mar. 4, 2022.

(51) Int. Cl. B60R 25/10; B60R 25/32; B60R 25/104; B60R 25/34; G08B 13/00

(52) U.S. Cl. CPC B60R 25/1001; B60R 25/32; B60R 25/104; B60R 25/1018; B60R 25/1004; B60R 25/34; G08B 13/00; B60R 2025/1013; B60R 25/31

(57) ABSTRACT

The present invention is a theft deterrent system for a catalytic converter. The present invention alerts anyone nearby an automotive vehicle when someone is trying to steal the catalytic converter. The underside of the automotive vehicle is monitored by the present invention and the present invention can act independently or be integrated into the existing alarm system. The present invention can be positioned at various points across the underside of the automotive vehicle in order to accommodate different types of automotive vehicles. Furthermore, the present invention may be integrated into an aftermarket automotive vehicle alarm system without attaching or physically connecting with the automotive vehicle catalytic converter. This allows the automotive vehicle catalytic converter to remain uninhibited by the present invention while still being monitored by the security system.

### FIELD OF THE INVENTION

The present invention generally relates to vehicle security systems. More specifically, the present invention is a theft deterrent system for a catalytic converter, utilizing programmable proximity-sensing technology.

### BACKGROUND OF THE INVENTION

Vehicle parts can cost tens of dollars to thousands of dollars depending on what the vehicle part is. Stripping vehicles of their parts is therefore a common issue and crime where security is not sufficient. One vehicle part that is frequently targeted is the catalytic converter. Due to its external positioning with vehicles, and more specifically being positioned underneath the vehicle, catalytic converters may be targeted as thieves are better able to access and or hide while disconnecting the catalytic converter from the vehicle. Catalytic converters and the cost to replace them can range from approximately $800 to $5200 depending on the year and model of the vehicle.

It is therefore an objective of the present invention to provide increased security for catalytic converters, and other valuable parts underneath a vehicle. The present invention provides constant, self-calibrating, and or, manually programmable, monitoring of the catalytic converter while the vehicle is turned off, or not in use. The present invention is able to determine if any disturbance or trigger is in fact a person attempting to steal the catalytic converter. The present invention may easily be attached to a vehicle or integrated into existing systems of a vehicle due to its modular design. Moreover, the present invention draws unwanted attention to a person stealing the catalytic converter of a vehicle and alerts the user or nearby individuals of the attempt.

### BRIEF DESCRIPTION OF THE DRAWINGS

FIG. 1 is bottom view of the present invention on the underside of an automotive vehicle.

FIG. 2 is a block diagram of the present invention.

FIG. 3 is a side view of the present invention showing the plurality of sensors that create various at least one trigger zones interacting with the ground beneath the automotive vehicle.

### DETAIL DESCRIPTIONS OF THE INVENTION

All illustrations of the drawings are for the purpose of describing selected versions of the present invention and are not intended to limit the scope of the present invention.

The present invention is a theft deterrent system for a catalytic converter. The present invention alerts an owner of an automotive vehicle 4 or individuals nearby the automotive vehicle 4 of any attempt to steal the catalytic converter of an automotive vehicle 4. It is understood that an automotive vehicle 4 may comprise at least one catalytic converter or a couple of catalytic converters, both of which are monitored by the present invention. Moreover, the present invention may be mounted to the underside of an automotive vehicle 4 and or integrated in an existing alarm system of the automotive vehicle 4. More specifically, the present invention's plurality of sensors 1 and an at least one deterrent devices 2 (which are lights, and or sirens) may be positioned at various points to the underside of the automotive vehicle 4 in order to accommodate different types of automotive vehicles. Furthermore, the present invention may be integrated into an aftermarket automotive vehicle alarm system 41. The present invention, or its sensors do not attach to or physically connect with the automotive vehicle catalytic converter 42. More specifically, the automotive vehicle catalytic converter 42 remains uninhibited by the present invention. It is understood that various embodiments of the present invention may be utilized to provide security to a variety of other automotive vehicle 4 parts positioned adjacent with the underside of the automotive vehicle 4. Other embodiments could be considered such as cargo or fuel theft protection.

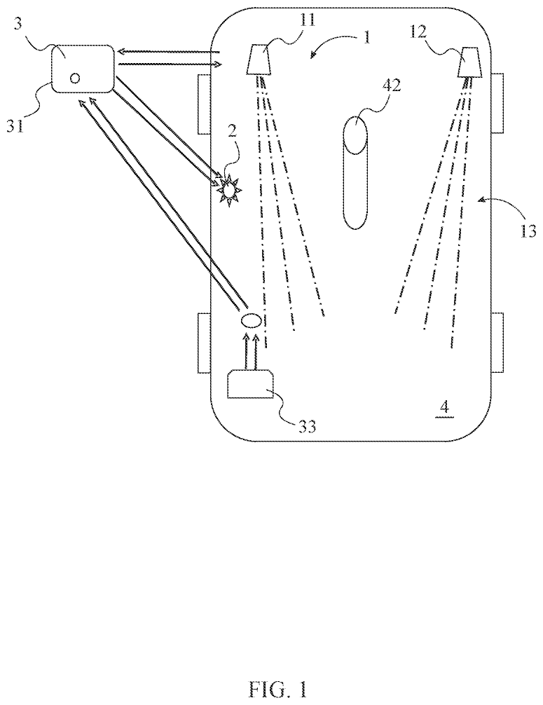

In order for the present invention to automatically monitor the automotive vehicle catalytic converter 42 while the automotive vehicle 4 is not in use, the present invention comprises a plurality of sensors 1, an at least one deterrent device 2 and a controller unit 3 as shown in FIG. 1. The plurality of sensors 1 is devices that detect if a person is handling or attempting to handle the automotive vehicle catalytic converter 42, and or raising a vehicle for access with a jacking device. The deterrent device 2 is an electronic device that alerts and notifies an owner of the corresponding automotive vehicle 4 or individuals in the nearby area of an attempted theft of the automotive vehicle catalytic converter 42. The controller is a device that houses various electronic components of the present invention. The plurality of sensors 1 comprises a left sensor 11, and or, a right sensor 12, and customized at least one trigger zones 13, created by a firmware. The at least one deterrent device 2 comprises an audio device 21 and a lighting device 22, that are electronically connected to the controller unit 3. The controller unit 3 comprises a physical housing 31, a wireless radio 32, a power source 33, a plurality of switches 34, and a at least one microcontroller 35. The plurality of sensors 1 is positioned along the underside of an automotive vehicle 4. As a result, the plurality of sensors 1 each independently monitor movement underneath the automotive vehicle 4. The plurality of sensors 1 detects attempted tampering with an automotive vehicle catalytic converter 42. Consequently, the plurality of sensors 1 receives input signals from the surrounding area below the automotive vehicle 4 inside and or outside the various programmed at least one trigger zones 13. The, at least one deterrent device 2 is positioned along the underside of an automotive vehicle 4, or wherever the at least one deterrent device 2 may be most effective. Accordingly, the at least one deterrent device 2 will create an audible sound and visible light directed at the location of the plurality of sensors 1. The controller unit 3 is secured within the automotive vehicle 4, under the hood or under the dashboard. Thus, the controller unit 3 is easily accessible to the driver of the automotive vehicle 4 and inaccessible to the individual attempting to steal the automotive vehicle catalytic converter 42. The controller unit 3 is electronically connected to the plurality of sensors 1 and the at least one deterrent device 2. So, the controller unit 3 is capable of sending and receiving signals from the plurality of sensors 1 and the at least one deterrent device 2.

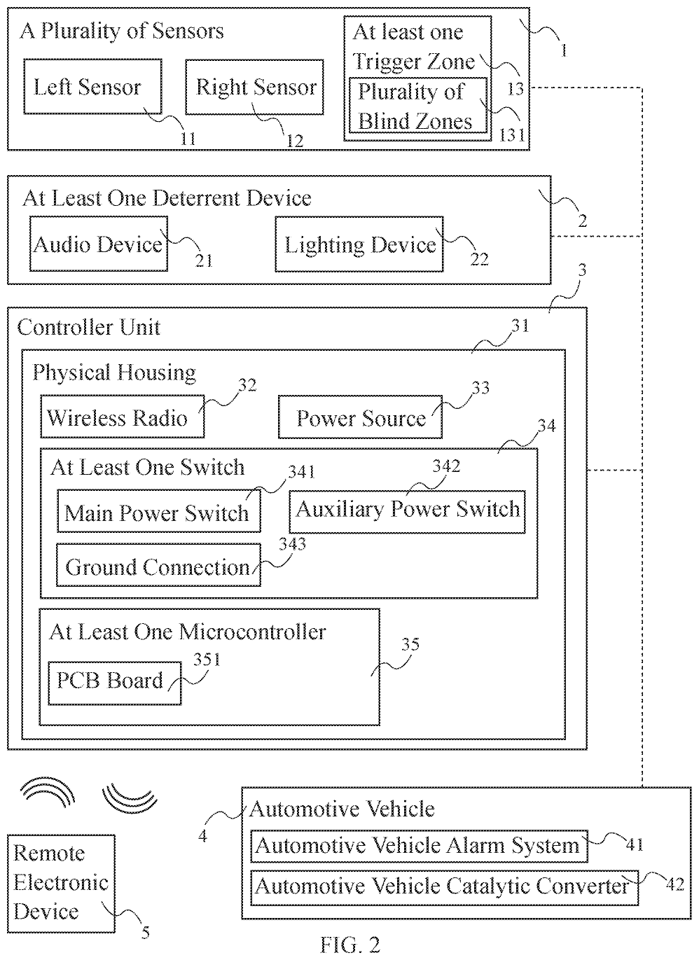

In reference to FIG. 2, the present invention monitors the surrounding area with a plurality of sensors 1. The plurality of sensors 1 is ultrasonic sensors. The plurality of sensors 1 is ultrasonic sensors, proximity sensors, IR sensors, radar sensors, or lidar sensors. As a result, the plurality of sensors 1 can detect a human presence when positioned below the automotive vehicle 4. The left sensor 11 is positioned along the left side of the underside of an automotive vehicle 4. Consequently, the left sensor 11 detects potential entry of a human attempting to steal an automotive vehicle catalytic converter 42 from the left side of the automotive vehicle 4. The right sensor 12 is positioned along the right side of the underside of an automotive vehicle 4. Accordingly, the right sensor 12 detects potential entry of a human attempting to steal an automotive vehicle catalytic converter 42 from the right side of the automotive vehicle 4.

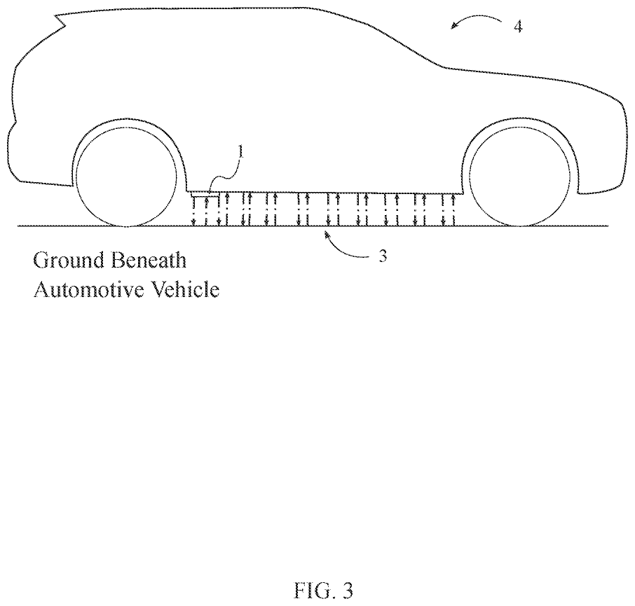

Further, the present invention monitors the area below the automotive vehicle 4, as well as the total detectable area between the plurality of sensors and the ground surface, even when the total distance detected has increased as seen in FIG. 3. The plurality of sensors 1 points towards the ground below the automotive vehicle 4. Thus, the plurality of sensors 1 receives inputs from the underside of the automotive vehicle 4 and the ground below the automotive vehicle 4. The plurality of sensors 1 operate perpendicular (90 degrees) to echo the surface/ground. The left sensor 11 independently creates a at least one trigger zone 13 with the surface/ground below the automotive vehicle. So, the left and right sensor 12 are utilized independently but work together within the controller unit 3 to create various programmed at least one trigger zones 13 which are target zones and or blind zones that is determined by the programmable software or firmware installed on the microcontroller 35. The at least one trigger zone 13 covers the space surrounding the automotive vehicle catalytic converter 42. As a result, an individual must cross at least one at least one trigger zone 13, and or, exceed the total programmed at least one trigger zone 13 to reach the automotive vehicle catalytic converter 42 in an attempt to steal it. For example, if the total measured distance between the automotive vehicle is 200 mm, and then the vehicle is jacked up to 240 mm, the at least one trigger zone 13 will be activated. The plurality of sensors does not bounce off each other and act independently of each other. Each of the plurality of sensors can be independently programmed with the controller unit. The plurality of sensors points to the hard surface of the ground, not at each other. The plurality of sensors can be mounted in front, back or left and right of the automotive vehicle. This allows the at least one trigger zones 13 to be controlled with the plurality of sensors 1 and the least one blind zone with the plurality of sensors 1, the controller unit 3, and the at least one deterrent device 2. This results in and allows the at least one trigger zone 13 to control inside or outside a maximum detected range between the plurality of sensors 1 and a surface, or beyond the parameters of the maximum distance detection. As a result, the plurality of sensors 1 monitors to the surface or ground below the automotive vehicle 4, for the prevention of an automotive vehicle catalytic converter 42 theft.

Furthermore, a plurality of blind zones 131 can be created above and below the at least one trigger zones, and or even in the middle of an at least one trigger zone 13 as shown in FIG. 3. The plurality of blind zones is positioned above, within, or below the at least one trigger zone 13 between the at least one trigger zone 13 and the ground below the automotive vehicle 4. The plurality of blind zones is an area that will not send a signal to the microcontroller 35 when an object is detected within the zone. The at least one trigger zones 13 can be created inside and or outside the max distances detected. For example, the plurality of sensors 1 can detect if the max distance is increased if for example, a thief is jacking up an automotive vehicle. The at least one trigger zone 13 covers the area from the underside of the automotive vehicle, and or between or, above the at least one trigger zones 4 to any percentage of the distance to the ground below the automotive vehicle 4, or above the at least one trigger zone 13, and or, even in the middle of a at least one trigger zone 13. Consequently, the at least one trigger zone 13 will only detect objects within a desired range. This will ensure that false alarms are not created based on small animals or objects accidently moving about underneath the underside of the automotive vehicle 4.

Furthermore, an alarm is set off when an object enters the at least one trigger zone 13, and or a vehicle is raised beyond the desired zone as seen in FIG. 2. The at least one deterrent device 2 is activated by the controller unit 3 using a pre-programmed timed alarm when an object quickly enters and leaves the at least one trigger zone 13. Accordingly, the at least one deterrent device 2 will create a predetermined short alarm when an object quickly enters the at least one trigger zone, and or the automotive vehicle 4 is jacked up beyond the at least one trigger zone 13. For example, if a small animal such as a squirrel or cat crawls below the automotive vehicle 4 a short alarm can be set off. The at least one deterrent device 2 receives a second alarm from the controller when an object stays within the at least one trigger zone 13 for a predetermined period of time. Thus, the at least one deterrent device 2 will receive a prolonged, predetermined alarm if the object underneath the automotive vehicle 4 is not quickly removed. The at least one deterrent device 2 receives a non-stop alarm signal from the controller unit 3 when an object stays within the at least one trigger zone 13 for a prolonged period of time, and or the at least one trigger zone 13 is exceeded. So, the at least one deterrent device 2 will continuously receive an alarm signal from the controller unit 3 if for example a thief is positioned underneath the automotive vehicle 4 and does not automatically leave. The at least one deterrent device alarm signal received from the controller 2 ends the non-stop alarm once the object is removed from the at least one trigger zone 13. Further, the controller unit 3 is programmed to recalibrate with predetermined settings in the controller for predetermined limits. Once the object is removed from the at least one trigger zone 13 the controller unit 3 and at least one deterrent device 2 stops making the non-stop alarm, recalibrates, and is set to an armed mode which is constantly monitoring the underside of an automotive vehicle 4.

In reference to FIG. 1, the at least one deterrent device 2 is positioned at the most effective area offset the plurality of sensors 1. As a result, the at least one deterrent device 2 does not interfere with the plurality of sensors 1. The audio device 21 produces a sound of at least 100 db. Consequently, the audio device 21 creates a loud and unpleasant sound for the individual attempting to steal the automotive vehicle catalytic converter 42, and or attempt to raise the automotive vehicle 4 and notifies nearby individuals of the attempted theft. The lighting device 22 produces a bright strobing light source. Accordingly, the lighting device 22 bright strobing light source is easily detectable by nearby individuals to bring attention to the attempted theft. Further, the present invention is controlled by the controller unit 3 as shown in FIG. 2. The at least one deterrent device 2 is electronically controlled by the controller unit 3. Thus, the at least one deterrent device 2 receives signals from the controller unit 3. The at least one deterrent device 2 turns on and off based on a condition sensed by the controller unit 3. For example, if the present invention is in “armed mode” the at least one deterrent device 2 will turn on if an object is detected by the plurality of sensors 1. If the present invention is in “unarmed mode” the at least one deterrent device 2 will turn off even if an object is detected by the plurality of sensors 1, and or the automotive vehicle 4 is raised.

In reference to FIG. 2, many of the electronic components are safely housed within the controller unit 3. The physical housing 31 surrounds the optional wireless radio 32, the at least one switch 34, and the at least one microcontroller 35. The physical housing 31 seals and protects the at least one switch 34, and the at least one microcontroller 35 from harmful elements. So, the physical housing 31 protects the at least one switch 34, and the at least one microcontroller 35 from external factors and harms. For example, under the hood of an automotive vehicle The optional wireless radio 32, that is not needed for full functionality and is an added feature, sends electronic signals to an optional external remote electronic device 5, or cell phone application. As a result, the optional wireless radio 32 can notify the owner of an automotive vehicle 4 if there was an attempt to steal their automotive catalytic converter. The wireless radio 32 could receive electronic signals from an external remote electronic device 5. Consequently, the optional wireless radio 32 can send and or receive signals from the controller unit 3, or to alert the user and or, allow the controller unit 3 to be turned on and off from the external remote electronic device 5.

Further, the present invention is provided with a source of power as shown in FIG. 2. The power source 33 is electrically connected to the controller unit 3, which powers a plurality of sensors 1, the at least one deterrent device 2, the optional wireless radio inside the controller 32, the at least one switch 34, and the at least one microcontroller 35. Accordingly, the plurality of sensors 1, the at least one deterrent device 2, the optional wireless radio 32, the at least one switch 34 and the at least one microcontroller 35 all receive electrical current from the power source 33. The power source 33 is an automotive vehicle 4 battery. The power source 33 is the automotive vehicle 4 battery or an external rechargeable battery. Thus, the power source 33 is provided by the existing automotive vehicle 4 battery or can utilize an external rechargeable battery.

In reference to FIG. 2, the at least one switch 34 is electronically connected to the at least one microcontroller 35. So, at least one switch 34 will control and turn the at least one microcontroller 35 on and off. The at least one switch 34 further comprises a main power switch 341, an auxiliary switch 342, a constant power wire and a ground connection 343. Further, the present invention power state is controlled primarily by the auxiliary power switch 342 as shown in FIG. 2. The auxiliary power switch 342 power state inversely corresponds with the power state of the automotive vehicle 4. For example, if the automotive vehicle 4 is turned on and running then the auxiliary power switch 342 will shut off the present invention to ensure that the present invention is not actively trying to detect objects underneath the automotive vehicle 4. The auxiliary power switch 342 controls the power flowing from the power source 33. As a result, the auxiliary power switch 342 determines if the at least one microcontroller 35, the plurality of sensors 1, and the at least one deterrent device 2 receive any power. The auxiliary power switch 342 is integrated into the automotive vehicle 4. Consequently, the vehicle ignition controls the power state of either being on or off of the auxiliary power switch 342. The main power switch 341 overriding the auxiliary power switch 342. Accordingly, the main power switch 341 will take precedence when controlling the power source 33 of the present invention.

The main power switch 341 controls the power flowing from the power source 33. The main power switch 341 is integrated into the physical housing 31. Thus, the present invention is easily turned on and off with convenient access for the owner of the vehicle. The ground connection 343 is secured to the automotive vehicle 4.

In reference to FIG. 2, the present invention is controlled by the microcontroller 35. The at least one microcontroller 35 further comprises a PCB board 351. The at least one microcontroller 35 controls the plurality of sensors 1 and the at least one deterrent device 2. So, the plurality of sensors 1 and at least one deterrent device 2 are calibrated and altered by the at least one microcontroller 35. The at least one microcontroller 35 can be remotely controlled by the optional remote electronic device 5. The remote electronic device 5 is not required as the main power switch 341 will suffice. As a result, the at least one microcontroller 35 can be optionally controlled the present invention remotely when the owner of the automotive vehicle 4 is not near the present invention. The PCB board 351 processes the inputs from the plurality of sensors 1.

Although the invention has been explained in relation to its preferred embodiment, it is to be understood that many other possible modifications and variations can be made without departing from the spirit and scope of the invention as hereinafter claimed.

What is claimed is:

1. A system for deterring catalytic converter theft comprising:
a plurality of sensors;
at least one deterrent device;
a controller unit;
the plurality of sensors comprising a left sensor, a right sensor, and a predetermined at least one trigger zones;
the at least one deterrent device comprising an audio device and a lighting device;
the controller unit comprising a physical housing, a power source, at least one switches, and at least one microcontroller;
the plurality of sensors being positioned along the underside of an automotive vehicle;
the plurality of sensors detecting attempted tampering, or lifting an automotive vehicle with an automotive vehicle catalytic converter;
the at least one deterrent device being positioned along the underside of an automotive vehicle, or where the device is most effective;
the controller unit being secured within the automotive vehicle; and
the controller unit being electronically connected to the plurality of sensors and the at least one deterrent device.

2. The system for deterring catalytic converter theft as claimed in claim 1 comprising:
the plurality of sensors being ultrasonic sensors;
the left sensor being positioned along the left side of the underside of an automotive vehicle; and
the right sensor being positioned along the right side of the underside of an automotive vehicle.

3. The system for deterring catalytic converter theft as claimed in claim 1 comprising:
the plurality of sensors being ultrasonic sensors, proximity sensors, IR sensors, radar sensors, or lidar sensors.

4. The system for deterring catalytic converter theft as claimed in claim 2 comprising:
the plurality of sensors pointing towards the ground below the automotive vehicle;
the left sensor creating at least one trigger zone with the ground; and
the at least one trigger zone covering the entry path to the automotive vehicle catalytic converter.

5. The system for deterring catalytic converter theft as claimed in claim 4 comprising:
the at least one trigger zone further comprising of at least one blind zone; and
the at least one trigger zone covering the area from the underside of the automotive vehicle up to the predetermined at least one trigger zone and the distance to the ground below the automotive vehicle.

6. The system for deterring catalytic converter theft as claimed in claim 5 comprising:
the at least one deterrent device creating a predetermined, timed second alarm when an object quickly enters and leaves the at least one trigger zone, and or raises the automotive vehicle beyond the predetermined at least one trigger zone;
the at least one deterrent device creating a predetermined timed second alarm when an object stays within the at least one trigger zone for a longer short period of time;
the at least one deterrent device receiving a non-stop alarm signal from the controller when an object stays within the at least one trigger zone for a prolonged period of time; and
the at least one deterrent device ending the non-stop alarm signal from the controller unit, once the object is removed from the at least one trigger zone, or the controller unit is recalibrated based on a predetermined firmware format.

7. The system for deterring catalytic converter theft as claimed in claim 1 comprising:
the at least one deterrent device being positioned offset the plurality of sensors;
the audio device producing a sound of at least 100 db; and
the lighting device producing a bright strobing light source.

8. The system for deterring catalytic converter theft as claimed in claim 7 comprising:
the at least one deterrent device being electronically controlled by the controller unit; and
the at least one deterrent device turning on and off based on a condition sensed by the plurality of sensors and the controller unit.

9. The system for deterring catalytic converter theft as claimed in claim 1 comprising:
the controller unit comprising an optional wireless radio;
the physical housing surrounding the optional wireless radio, the at least one switch, and the at least one microcontroller;
the physical housing sealing the optional wireless radio, the at least one switch, and the at least one microcontroller from harmful elements;
the optional wireless radio sending electronic signals to an external remote electronic device; and
the optional wireless radio receiving electronic signals from an external remote electronic device.

10. The system for deterring catalytic converter theft as claimed in claim 9 comprising:
the power source being electrically connected to the plurality of sensors, the at least one deterrent device, the optional wireless radio, the plurality of switches, and the at least one microcontroller; and
the power source being an automotive vehicle battery.

11. The system for deterring catalytic converter theft as claimed in claim 9 comprising the power source being the automotive vehicle battery or an external rechargeable battery.

12. The system for deterring catalytic converter theft as claimed in claim 1 comprising:
the at least one switch being electronically connected to the at least one microcontroller; and
the at least one switch further comprising a main power switch, an auxiliary power switch and a ground connection, all controlled by the at least one switch.

13. The system for deterring catalytic converter theft as claimed in claim 12 comprising:
the auxiliary power switch power state inversely corresponding with the power state of the automotive vehicle;
the auxiliary power switch controlling the power flowing from the power source; and
the auxiliary power switch being integrated into the automotive vehicle.

14. The system for deterring catalytic converter theft as claimed in claim 12 comprising:
the main power switch overriding the auxiliary power switch;
the main power switch controlling the power flowing from the power source;
the main power switch being integrated into the physical housing; and
the ground connection being secured to the automotive vehicle.

15. The system for deterring catalytic converter theft as claimed in claim 1 comprising:
the at least one microcontroller further comprising a PCB board;
the at least one microcontroller controlling the plurality of sensors and the at least one deterrent device;
the at least one microcontroller being remotely controlled by the optional remote electronic device;
the PCB board processing the inputs from the plurality of sensors;
controlling the at least one trigger zones with the plurality of sensors and the least one blind zone with the plurality of sensors, the controller unit, and the at least one deterrent device;
the trigger zone controlling inside or outside a maximum detected range between the plurality of sensors and a surface, or beyond the parameters of the maximum distance detection; and
the plurality of sensors monitoring to the surface, for the prevention of catalytic converter theft.

16. A system for deterring catalytic converter theft comprising:
a plurality of sensors;
at least one deterrent device;
a controller unit;
the plurality of sensors comprising left sensor, a right sensor, and predetermined at least one trigger zones;
the at least one deterrent device comprising an audio device and a lighting device;
the controller unit comprising a physical housing, a power source, at least one switch, and at least one microcontroller;
the plurality of sensors being positioned along the underside of an automotive vehicle;
the plurality of sensors detecting attempted tampering with an automotive vehicle catalytic converter;
the at least one deterrent device being positioned along the underside of an automotive vehicle;
the controller unit being secured within the automotive vehicle, or under the hood of the automotive vehicle;
the controller unit being electronically connected to the plurality of sensors and the at least one deterrent device;
the plurality of sensors being ultrasonic sensors;
the left sensor being positioned along the left side of the underside of an automotive vehicle, or where the plurality of sensors will be most effective;
the right sensor being positioned along the right side of the underside of an automotive vehicle; and
the plurality of sensors being ultrasonic sensors, proximity sensors, IR sensors, radar sensors, or lidar sensors.

17. The system for deterring catalytic converter theft as claimed in claim 16 comprising:
the plurality of sensors pointing towards the ground below the automotive vehicle;
the left sensor creating independent at least one trigger zones with the ground;
the at least one trigger zone covering the entryway and or lifting of the automotive vehicle to access automotive vehicle catalytic converter;
the at least one trigger zone further comprising at least one blind zone;
the at least one trigger zone covering the area from the underside of the automotive vehicle up to predetermined distances to the ground below the automotive vehicle;
the at least one deterrent device creating receiving a predetermined timed alarm from the controller when an object quickly enters and leaves the at least one trigger zone;
the at least one deterrent device creating a predetermined timed alarm when an object stays within the at least one trigger zone for a predetermined period of time;
the at least one deterrent device creating a non-stop alarm when an object stays within the at least one trigger zone for a prolonged period of time; and the controller sends an alarm signal
the at least one deterrent device ending the non-stop alarm once the object is removed from the at least one trigger zone; or, the predetermined firmware recalibrates
the at least one deterrent device being positioned offset the plurality of sensors;
the audio device producing a sound of at least 100 db;
the lighting device producing a bright light source;
the at least one deterrent devices being electronically controlled by the controller unit; and
the at least one deterrent device turning on and off based on a condition sensed by the controller unit.

18. The system for deterring catalytic converter theft as claimed in claim 16 comprising:
the controller unit comprising an optional wireless radio;
the physical housing surrounding the optional wireless radio, the at least one switch, and the at least one microcontroller;
the physical housing sealing the wireless radio, the at least one switch, and the at least one microcontroller from harmful elements;
the optional wireless radio sending electronic signals to an external remote electronic device;
the wireless radio receiving electronic signals from an external remote electronic device;
the controller power source being electrically connected to the plurality of sensors, the at least one deterrent device, the optional wireless radio in the controller, the at least one switch, and the at least one microcontroller;
the power source being an automotive vehicle battery;
the power source being the automotive vehicle battery or an external rechargeable battery;
the plurality of switches being electronically connected to the at least one microcontroller;
the at least one switch further comprising a main power switch, an auxiliary power switch and a ground connection;
the auxiliary power switch power state inversely corresponding with the power state of the automotive vehicle;
the auxiliary power switch controlling the power flowing from the power source;
the auxiliary power switch being integrated into the automotive vehicle;
the main power switch overriding the auxiliary power switch;
the main power switch controlling the power flowing from the power source;
the main power switch being integrated into the physical housing;
the ground connection being secured to the automotive vehicle;
the at least one microcontroller further comprising a PCB board;
the at least one microcontroller controlling the plurality of sensors and the at least one deterrent device;
the at least one microcontroller being remotely controlled by the optional but not needed remote electronic device; and
the PCB board processing the inputs from the plurality of sensors.

19. A system for deterring catalytic converter theft comprising:
a plurality of sensors;
an at least one deterrent device;
a controller unit;
the plurality of sensors comprising at least one left sensor, and or a right sensor, and at least one predetermined at least one trigger zone;
the at least one deterrent device comprising an audio device and a lighting device;
the controller unit comprising a physical housing, a power source, a plurality of switches, and at least one microcontroller;
the plurality of sensors being positioned along the underside of an automotive vehicle;
the plurality of sensors detecting attempted tampering with an automotive vehicle catalytic converter or raising a vehicle to access the catalytic converter;
the at least one deterrent device being positioned along the underside of an automotive vehicle;
the controller unit being secured within the automotive vehicle;
the controller unit being electronically connected to the plurality of sensors and the at least one deterrent device;
the plurality of sensors being ultrasonic sensors;
the left sensor being positioned along the left side of the underside of an automotive vehicle;
the right sensor being positioned along the right side of the underside of an automotive vehicle;
the plurality of sensors being ultrasonic sensors, proximity sensors, IR sensors, radar sensors, or lidar sensors;
the plurality of sensors pointing towards perpendicular the ground below the automotive vehicle;
the left sensor creating the at least one at least one trigger zone with the ground;
the at least one trigger zone covering either side of the automotive vehicle catalytic converter;
the at least one trigger zone further comprising a the at least one blind zone;
the at least one trigger zone covering the area from the underside of the automotive vehicle up to a predetermined distance to the ground below the automotive vehicle;
the at least one deterrent device creating a predetermined timed alarm when an object quickly enters and leaves the at least one trigger zone;
the at least one deterrent device creating another predetermined timed alarm when an object stays within the at least one trigger zone for a longer period of time;
the at least one deterrent device creating a non-stop alarm when an object stays within the at least one trigger zone for a prolonged period of time;
the at least one deterrent device ending the non-stop alarm once the object is removed from the at least one trigger zone or the controller recalibrates with predetermined firmware;
the at least one deterrent device being positioned offset the plurality of sensors;
the audio device producing a sound of at least 100 db;
the lighting device producing a bright light source;
the at least one deterrent device being electronically controlled by the controller unit; and
the at least one deterrent device turning on and off based on a condition sensed by the controller unit.

20. The system for deterring catalytic converter theft as claimed in claim 19 comprising:
the controller unit the controller unit comprising an optional wireless radio;
the physical housing surrounding the optional wireless radio, the at least one switch, and the at least one microcontroller;
the physical housing sealing the wireless radio, the at least one switch, and the at least one microcontroller from harmful elements;
the optional wireless radio sending electronic signals to an optional external remote electronic device;
the optional wireless radio receiving electronic signals from an optional external remote electronic device;
the power source being electrically connected to the controller, the plurality of sensors, the at least one deterrent device, the wireless radio, the plurality of switches, and the at least one microcontroller;
the power source being an automotive vehicle battery;
the power source being the automotive vehicle battery or an external rechargeable battery;
the plurality of switches being electronically connected to the at least one microcontroller;
the at least one switches further comprising a main power switch, an auxiliary power switch and a ground connection;
the auxiliary power switch power state inversely corresponding with the power state of the automotive vehicle;
the auxiliary power switch controlling the power flowing from the power source;
the auxiliary power switch being integrated into the automotive vehicle;
the main power switch overriding the auxiliary power switch;
the main power switch controlling the power flowing from the power source;
the main power switch being integrated into the physical housing;
the ground connection being secured to the automotive vehicle;
the at least one microcontroller further comprising a PCB board;
the at least one microcontroller controlling the plurality of sensors and the at least one deterrent device;
the at least one microcontroller being optionally remotely controlled by the optional remote electronic device; and
the PCB board processing the inputs from the plurality of sensors.
